(19) United States
(12) Patent Application Publication
(10) Pub. No.: US 2026/0062358 A1
(43) Pub. Date: Mar. 5, 2026

(54) PLASTERBOARD AND MANUFACTURE THEREOF

(71) Applicant: SAINT-GOBAIN PLACO, COURBEVOIE (FR)

(72) Inventors: Zoé RHODES, COURBEVOIE (FR); Christine NGUYEN, COURBEVOIE (FR); Olivier FRANCY, COURBEVOIE (FR)

(73) Assignee: SAINT-GOBAIN PLACO, COURBEVOIE (FR)

(21) Appl. No.: 19/105,090

(22) PCT Filed: Aug. 23, 2023
(86) PCT No.: PCT/EP2023/073101

§ 371 Date: Feb. 20, 2025

(30) Foreign Application Priority Data
Aug. 23, 2022 (FR) FR2208467

(51) Int. Cl. C04B 38/00; B28B 19/00; B32B 7/022; B32B 13/08; C04B 28/14; C04B 38/10; C04B 111/00; C04B 111/40

(52) U.S. Cl. CPC C04B 38/0058; B28B 19/0092; B32B 7/022; B32B 13/08; C04B 28/146; C04B 28/147; C04B 38/0054; C04B 38/10; B32B 2250/03; B32B 2250/40; B32B 2305/026; B32B 2307/718; B32B 2607/00; C04B 2111/0062; C04B 2111/40

(57) ABSTRACT

The invention relates to plasterboard comprising a plaster core arranged between two cover sheets;
wherein said plaster core comprises a matrix of gypsum crystals and air pores;
wherein at least 90%, preferably at least 94%, more preferably at least 98%, of the air pores are connected by a constriction; and
wherein the average neighbor coordination of the connected air pores is between 2 and 6, preferably between 3 and 5.

### TECHNICAL FIELD

The invention relates to a plasterboard and its production method.

### TECHNICAL BACKGROUND

Plasterboards for wall and ceiling systems is a well-known application of plaster (gypsum), calcium sulfate dihydrate CaSO₄·2(H₂O). It consists of a plaster core sandwiched between two, usually paper-based, cover sheets.

The base material from which the matrix of gypsum crystals of the plaster core is made is a calcium sulfate hemihydrate CaSO₄ 0.5(H₂O), also known as “stucco”, which is produced by dehydrating or calcining gypsum CaSO₄·2(H₂O) to remove 1.5 molecules of water.

Calcium sulfate hemihydrate comes in two forms: alpha calcium sulfate hemihydrate (α hemihydrate) produced from calcined gypsum in an atmosphere saturated with water vapor, and beta calcium sulfate hemihydrate (β hemihydrate) produced under conditions where the partial pressure of water vapor is low. Alpha and beta calcium sulfate hemihydrates can be used to produce plasterboard. Alpha calcium sulfate hemihydrate tends to provide a harder plasterboard with greater strength and density.

Porosity is introduced into the plaster matrix to reduce the weight of the plasterboard, improve its sound absorption and strength, and reduce dust generation during mechanical processing, for example cutting, screwing/nailing.

Porosity is often classified into water pores and air pores. Water pores are produced when excess water evaporates from the slurry. Air pores are produced using a foaming agent and/or an aeration device. Water pores are generally irregularly shaped, complex, entangled in the matrix of gypsum crystals, and connected to one another to form a continuous network between gypsum crystals. Air pores are generally spherical in shape, separated from one another and not connected to form a continuous network. Water pores can be distributed within the air pore walls.

In the plaster production method, large quantities of water are consumed to form plaster slurries. Most of this water is removed by drying. A drying method is costly because it requires large amounts of energy to evaporate the water. It is also time-consuming, as it takes some time for the water to migrate through the slurry and reach the surface.

Document WO 2008063295 A2 (UNITED STATES GYPSUM CO [US]) dated May 29, 2008 describes a plasterboard having a total porosity of approximately 80% to 92%, water pores having a size of less than 5 μm in diameter and air pores having a specific size distribution which makes it possible to reduce the generation of dust during mechanical processing, for example cutting, screwing/nailing, of the plasterboard . . . . Plasterboard is produced using a plaster slurry having a high water-to-stucco ratio (WSR), typically above 0.7.

Document WO 2009074875 A1 (LAFARGE PLÂTRES [FR]) dated Jun. 18, 2009 describes a sound-absorbing, mechanically strong plasterboard comprising a porous plaster core having high tortuosity, that is, a relatively low-porosity plaster core having low connectivity between air pores. Reducing the connectivity, i.e., the percolation rate, of air pores improves mechanical strength. Plasterboard is preferably produced using a plaster slurry having a water-to-stucco ratio (WSR) of between 0.45 and 0.75.

WO 2022153181 A1 [KNAUF GIPS KG [DE] dated Jul. 31, 2022 describes a soundproofing panel comprising an open-cell plaster core consisting of an entangled plaster matrix having air pores interconnected by open channels. The channels are distributed throughout the entangled matrix, forming complex, tortuous, labyrinth-like paths through the structure for acoustic waves to penetrate, travel through and be absorbed. The method for obtaining the material constituting the board described in this application is a standard method in which a water-based foam is produced from water and a foaming agent. This foam is then added and mixed with a slurry of the other ingredients in the initial formulation, this initial slurry being obtained in particular from a mixture of water and calcium sulfate hemihydrate. However, such a method cannot achieve a neighbor coordination of at least 2 of the connected air pores in the final structure.

### SUMMARY OF THE INVENTION

### Technical Problem

Increased porosity in plasterboard is often sought to reduce its weight, improve its acoustic properties and reduce dust generation during mechanical processing. However, a high level of porosity can quickly become detrimental to the mechanical strength of the board and may require a high water-to-stucco ratio (WSR) which, in turn, in addition to water consumption, also increases energy consumption during the subsequent drying stage.

Reducing porosity, on the other hand, increases mechanical strength and lowers the water-to-stucco ratio (WSR), thus reducing water and energy consumption. However, all the advantages of sound absorption, lightness and strength are lost.

### Solution to the Technical Problem

A first aspect of the description proposes a plasterboard comprising a plaster core arranged between two cover sheets;
wherein said plaster core comprises a matrix of gypsum crystals and air pores;
wherein at least 90%, preferably at least 94%, more preferably at least 98%, of the air pores are connected by a constriction; and
wherein the average neighbor coordination of the connected air pores is between 1.1 and 6, preferably between 3 and 5.

Other advantageous embodiments are described below.

A second aspect of the description proposes a method for producing a plasterboard according to the first aspect of the invention.

### Advantages of the Invention

An exceptional advantage of the present description is that of providing a plasterboard having reduced weight and improved acoustic properties, while reducing dust generation during mechanical processing and the water-to-stucco ratio (WSR) for its production. This is achieved by virtue of a special design of the air pore network in the gypsum matrix of the plaster core.

### BRIEF DESCRIPTION OF THE DRAWINGS

FIG. 1 is a block diagram of a plasterboard.

FIG. 2 is a block diagram of an example of plasterboard according to the first aspect of the invention.

FIG. 3 is a schematic representation of a detail II of the plasterboard of FIG. 2.

FIG. 4 is a graph showing the distribution of the air pore neighbor coordination for examples of plasterboard according to the first aspect of the invention.

FIG. 5 is a graph showing the variation in wall thicknesses of the connected air pores for examples of plasterboard according to the first aspect of the invention.

FIG. 6 is a graph showing the variation in wall thicknesses of the unconnected air pores for examples of plasterboard according to the first aspect of the invention.

FIG. 7 is a graph of the cumulative volume distribution of the equivalent diameter of the connected air pores for examples of plasterboard according to the first aspect of the invention.

FIG. 8 is a graph of the cumulative volume distribution of the equivalent diameter of the unconnected air pores for examples of plasterboard according to the first aspect of the invention.

FIG. 9 is a graph showing the average neighbor coordination of the air pores depending on the average diameter of the connected air pores for examples of plasterboard according to the first aspect of the invention.

FIG. 10 is a graph showing the variation in the average neighbor coordination of the air pores depending on the porosity for examples of plasterboard according to the first aspect of the invention.

FIG. 11 is a graph showing the variation in the average air pore neighbor coordination depending on the air permeability (Darcy's K) for examples of plasterboard according to the first aspect of the invention.

FIG. 12 is a scanning electron microscopy (SEM) photograph of the porous structure obtained according to Example 1 of the invention.

### DETAILED DESCRIPTION OF EMBODIMENTS

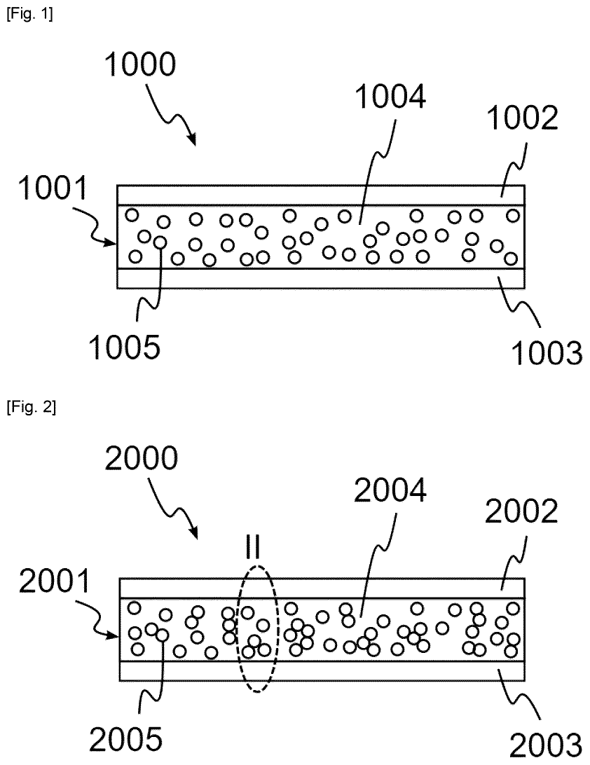

With reference to FIG. 1, a plasterboard 1000 comprises a plaster core 1001 sandwiched between two cover sheets 1002, 1003. The plaster core 1001 comprises a matrix 1004 of gypsum crystals consisting mainly of calcium sulfate hemihydrate CaSO₄ 0.5(H₂O) and air pores 1005. The air pores 1005 are generally spherical in shape, separated from one another and not connected to form a continuous network.

The plaster core 1001 may also include water pores (not shown). They are generally irregularly shaped and complex in the matrix of gypsum crystals 1004 so as to form a continuous network between the gypsum crystals.

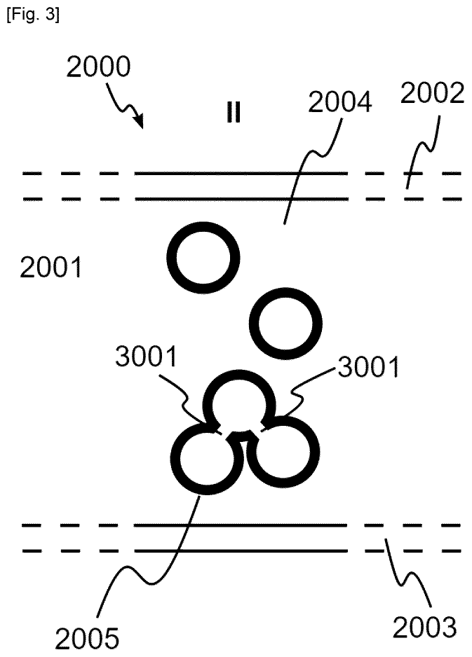

In the first aspect of the invention, with reference to FIG. 2 and FIG. 3, a plasterboard 2000 is proposed, comprising a plaster core 2001 arranged between two cover sheets 2002, 2003;
wherein said gypsum core 2001 comprises a matrix of gypsum crystals 2004 and air pores 2005;
wherein at least 90%, preferably at least 94%, more preferably at least 98%, of the air pores 2005 are connected by a constriction 3001; and
wherein the average neighbor coordination of the connected air pores 2005 is between 1.1 and 6, preferably between 3 and 5.

In the context of the invention, a “constriction” connecting air pores is to be understood as it is currently defined in the technical field, i.e., as an opening through the walls of two adjacent air pores so as to form a communication channel, path or window between them. An illustrative example is shown in FIG. 3.

In the context of the invention, a “neighbor coordination” of a connected air pore is the number of adjacent neighboring air pores to which it is connected by a constriction. The average neighbor coordination is the average of the neighbor coordination that is measured or calculated for all connected air pores.

Neighbor coordination can be measured by any suitable method, for example, image processing of MBE micrographs of cross-sections of plaster core samples and/or 3D X-ray tomography image processing of solid plaster core samples. Methods based on X-ray tomography may be preferred as they can be more accurate than methods based on MBE micrographs, which require more data to be statistically representative of volume samples.

As previously mentioned, a plasterboard according to the first aspect of the invention can have reduced weight and improved acoustic properties, while reducing dust generation during mechanical processing, and the water-to-stucco ratio (WSR) for its production. Without being bound by any theoretical explanation, it is assumed that an adjusted level of connectivity between the air pores of a plaster core will improve acoustic insulation and reduce weight, while limiting the amount of water to be used in production. It can be considered an advantageous compromise in terms of porosity, while at the same time offering the benefits of sound insulation, lightness, mechanical strength and water savings.

In some embodiments, the maximum volume of connected pores is at least 60%, more preferably at least 75%.

In some embodiments, the specific mass of the matrix of gypsum crystals can be at least 55%, preferably at least 65%, more preferably greater than 70%, of the nominal specific mass of the gypsum.

The specific mass of the matrix of gypsum crystals can be measured by any suitable method or apparatus, for example, hydrostatic balances or gas pycnometers.

The nominal specific mass of the gypsum may depend on the quantities of the various gypsum phases and other compounds forming the crystals of the matrix of gypsum crystals. For example, when the gypsum crystal is composed solely of calcium sulfate hemihydrate CaSO₄ 0.5(H₂O), the nominal specific mass of the gypsum may be close to the specific mass of the calcium sulfate hemihydrate, i.e., 2.73 g/cm³. The specific mass of the matrix of gypsum crystals can then be at least 1.50 g/cm³, preferably 1.77 g/cm³, more preferably greater than 1.91 g/cm³.

In some embodiments, the average equivalent diameter of the air pore constrictions may be less than 100 μm, preferably less than 80 μm, more preferably less than 60 μm.

In the context of the invention, the diameter of a constriction between air pores can be interpreted as the diameter of the largest tube that can be used to model this constriction. In practice, as the wall thickness between air pores that are connected by a constriction can be relatively small, the constriction can be modeled as a circular hole, and the diameter of the constriction can be the diameter of the largest circle that can be drawn to model this hole, or the diameter of a circle having the same area as the constriction.

Constrictions can be identified and their diameter calculated by image processing of 2D MBE micrographs and/or 3D X-ray tomography images. As with neighbor coordination, X-ray tomography-based methods may be preferred as they can acquire 3D images that are more representative of volume samples.

Air pores connected to one another by a constriction may have thinner walls than unconnected air pores due to their proximity. As constrictions create channels within the porous structure and reduce the wall surface area of air pores, excessively thin walls can lead to greater sensitivity to external mechanical aggression on the part of the plaster core. The porous structure can easily collapse, and the plaster be easily crushed when external mechanical stresses, such as compressive stresses due to screwing, are applied. Of course, the collapse of the porous structure may depend on the intensity of the mechanical stresses applied, and in some applications in which low mechanical stresses applied to the plasterboard can be expected, it may be unnecessary to avoid a more brittle porous structure.

Image processing of MBE micrographs of plaster core sample cross-sections should be avoided for measuring air pore wall thickness, as many micrographs acquired on different cross-sections may be required for the measurement to be statistically representative of the actual air pore wall thicknesses in the volume sample.

Instead, the processing of 3D X-ray tomography images may be recommended. 3D images can be used to reconstruct the 3D distribution of air pores in a volume sample. By measuring the distance between the centers of two adjacent air pores and subtracting their respective radii, a distribution of wall thickness values can be calculated.

In advantageous embodiments, the wall thicknesses of the connected air pores can further be between 2 μm and 20 μm, with the average wall thickness of the connected pores being between 2 μm and 15 μm, preferably between 3 μm and 10 μm. Plasterboard comprising a plaster core having connected air pores which have a wall thickness as described can exhibit higher mechanical strength.

Unconnected air pores can generally be further apart, and therefore may have thicker walls. Thicker walls can increase the overall specific mass of the plaster core. This can be detrimental for applications requiring lighter plasterboard.

Thus, in some advantageous embodiments, the wall thicknesses of unconnected air pores can further be between 5 μm and 150 μm, with the average wall thickness of the unconnected pores being between 25 μm and 75 μm, preferably between 30 μm and 60 μm. Unconnected air pores of this wall thickness make it possible to reduce the weight of plasterboard without compromising mechanical strength.

As a first approach, large connected air pores, i.e., large diameter air pores, can be considered valuable for reducing the weight of the plaster core, and thus lowering its specific mass, and reducing dust generation during mechanical processing. However, excessively large connected air pores can have a negative impact on the toughness of the plaster core, reducing its ability to withstand mechanical stress. During mechanical processing, the plaster core may break unexpectedly.

In some advantageous embodiments, the average diameter of the air pores connected by a neighbor connectivity of between 2 and 6 can be less than 300 μm, preferably less than 250 μm, more preferably less than 200 μm. It has been found that these values tend to provide lightweight, durable and robust plasterboards.

Without being limited in any way to any specific range of specific masses for a plasterboard according to the invention, it has been found that a plasterboard can exhibit the best performance within an optimum range of specific masses. Thus, in certain advantageous embodiments, the specific mass of the plasterboard can advantageously be between 5 kg/m² and 15 kg/m², preferably between 5 kg/m² and 10 kg/m².

Total porosity, including air and water pores, directly affects the specific mass of the plaster core and therefore the specific mass of the plasterboard. Since air pores contribute most to the final specific mass of the plaster core, the total fraction of air pores, whether connected or unconnected, can be used as an approximation to qualify the lightness level of a plasterboard.

Thus, in some advantageous embodiments, the average diameter of connected and unconnected air pores can be less than 300 μm, preferably less than 250 μm, more preferably less than 200 μm, for an overall porosity of between 45% and 85%. Such a wide range of air pore diameters can be useful for reducing the weight of the plaster core and dust generation during mechanical processing, while maintaining a high level of lightness.

Air pores that are too small can hinder the achievement of an average neighbor coordination of connected air pores 2005 of between 2 and 6, preferably between 3 and 5. Preferably, in some embodiments, 85% of the porosity volume of the air pores can consist of air pores having a diameter of greater than 100 μm, preferably greater than 150 μm.

The pore size distribution, whether air pore or water pore, in the plaster core of plasterboard according to the description can be unimodal or multimodal, for example, bimodal.

Thus, with regard to the air pore size distribution, in exemplary embodiments at least 50% by volume, preferably at least 75% by volume, of the air pores may have a diameter of less than 150 μm, and at least 25% by volume, preferably 45% by volume, of the air pores may have a diameter of greater than 100 μm.

Furthermore, with regard to the water pore size distribution, in exemplary embodiments, 50% to 90% of the water pores may have a diameter of less than 3 μm and 5% to 30% of the water pores may have a diameter of greater than 3 μm.

Air permeability measures the ability of a fluid, such as air, to flow through a material. It can be used to measure the airtightness of a building material and, since it is linked to the open pore network, it can be used to characterize said open network. While the open pore network can include both connected air pores and water pores, connected air pores generally contribute most to the overall porosity of the plasterboard and the contribution of water pores can be neglected. Air permeability can then be used as an approximation to characterize the open pore structure formed by connected air pores. Methods based on Darcy's law are commonly used to measure the air permeability of plaster cores or plasterboard.

In some advantageous embodiments, the Darcy's law air permeability for a plaster according to the invention can be between 10⁻¹⁰ and 10⁻¹³ m², preferably between 10⁻¹⁰ and 10⁻¹² m².

In a second aspect of the description, a method for producing plasterboard according to any one of the embodiments of the first aspect of the invention is proposed, wherein said method comprises the following steps:
forming a plaster slurry comprising at least 90%, preferably at least 95%, alpha gypsum hemihydrate;
mixing the plaster slurry with an aqueous solution of the foaming agent;
foaming the mixture of the slurry with the aqueous solution of the foaming agent, in particular in a mixer-aerator;
pouring the plaster slurry onto a first cover sheet;
applying a second cover sheet to the poured plaster slurry;
drying the slurry.

The method according to the second aspect of the invention can be designed to produce plasterboard according to any embodiment of the first aspect. In particular, the amount of foaming agent and/or the aeration time through the mixer-aerator can be adjusted according to the porosity and specific mass requirements to be met.

As mentioned above, one of the exceptional advantages of plasterboard according to the first aspect of the invention is that its production requires a low WSR. Thus, in preferred embodiments, in the method, the water-to-stucco ratio of the plaster slurry can be less than 0.5, preferably less than 0.4.

### EXAMPLES

The features and benefits are now illustrated by means of the examples described below.

Four examples E1 to E4 of plasterboard according to the invention were produced according to the production formulations in Table 1 for their plaster slurries. The plaster slurries of Examples E1 and E2 are made from alpha hemihydrates (HH alpha) with a water-to-stucco ratio (WSR) of 31%, while those of Examples E3 and E4 are prepared from beta hemihydrates (HH beta) with a WSR of 80%.

Furthermore, a retarder in the form of an aqueous solution of PlastRetard® from SICIT, diluted to 10% by weight (PlastRetard®), a dispersing agent in the form of sodium polynaphthalene sulfonate (PNS) and a heat-resistant accelerator (HRA) in the form of a mixture of ground plaster particles coated with a calcination-inhibiting coating as described in U.S. Pat. No. 3,573,947 A [UNITED STATES GYPSUM CO] dated Apr. 6, 1971 are added to the slurries in the proportion indicated in Table 1.

The foaming agent is an aqueous solution of Hyonic® PFM-10 diluted to 6% by weight and introduced into the slurries at 0.17 l/min before foaming by introducing air into the mixture thus formed at different flow rates, as described in Table 1.

According to the present invention, the foaming agent in aqueous form is therefore pre-mixed with the plaster slurries prior to foaming of the mixture thus formed, said foaming enabling the formation of the connected porosity.

TABLE 1

| | E1 | E2 | E3 | E4 |
|---|---|---|---|---|
| HH type | Alpha | Alpha | Beta | Beta |
| HH (g) | 2,000 | 2,000 | 2,000 | 2,000 |
| Water (g) | 612 | 612 | 1,566 | 1,566 |
| HRA (g) | 8 | 8 | 4 | 4 |
| PlastRetard ® (g) | 8 | 8 | 30 | 30 |
| PNS (g) | 10 | 10 | 6 | 6 |
| Air flow (l/min) | 4 | 2 | 2 | 1 |
| Flow rate of foaming | 0.17 | 0.17 | 0.17 | 0.17 |
| agent (L/min) | | | | |
| WSR of the slurry | 31% | 31% | 80% | 80% |

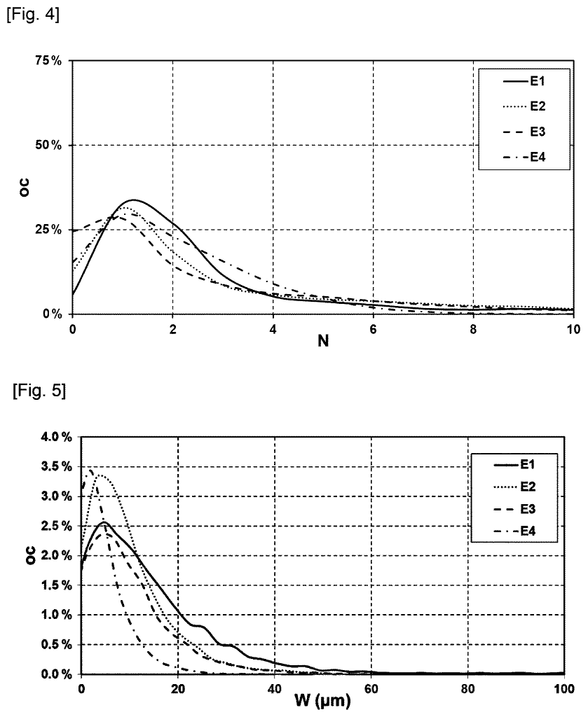

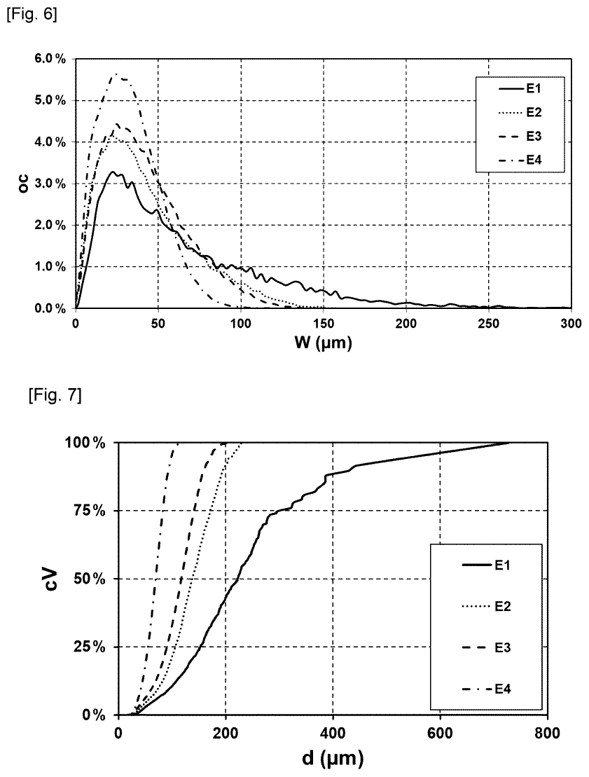

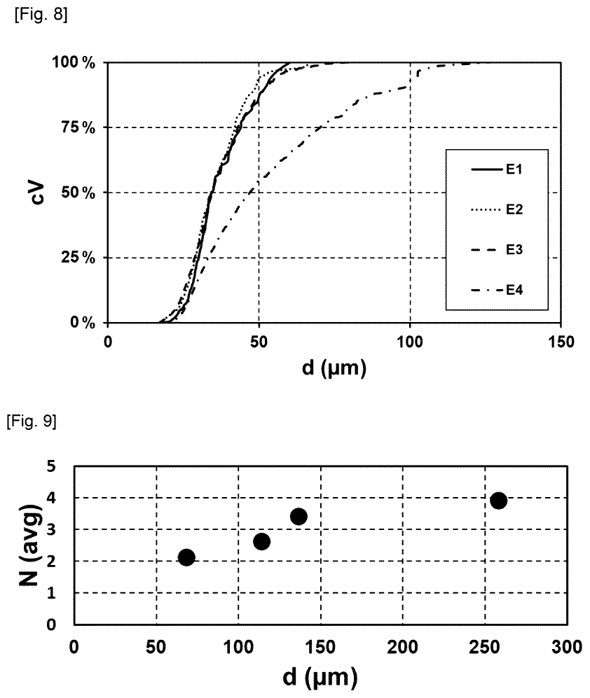

Once prepared, the plasterboards of Examples E1 and E4 were analyzed by X-ray tomography and various structural features of the plaster core were extracted and measured by processing the 3D images acquired by X-ray tomography. In particular, the following features were extracted:
the distribution, by occurrence, of the neighbor coordination, N, of air pores, FIG. 4;
the distribution, by occurrence, oc, of wall thicknesses, W (μm), of connected air pores, FIG. 5;
the distribution, by occurrence, oc, of wall thicknesses, W (μm), of unconnected air pores, FIG. 6;
the cumulative volume distribution, cV, of equivalent diameter, d (μm) of connected air pores, FIG. 7;
the cumulative volume distribution, cV, of equivalent diameter, d (μm) of unconnected air pores, FIG. 8.

Furthermore, the average neighbor coordination, the average wall thickness of connected air pores, the average wall thickness of unconnected pores, the average equivalent diameter of constrictions and the average diameter of connected air pores were also calculated. The results are shown in Table 2.

The air permeability, Darcy's K, of each example was measured respectively by a method based on Darcy's law according to ISO 8841. Porosity was calculated from the measured weight of the plasterboards. The results are shown in Table 2.

The mechanical strength of each example was measured by mechanical indentation. An 8 mm spherical ball is driven into the plank at a constant speed, while the slope of the resistance/displacement curve is measured. The results are shown in Table 2.

TABLE 2

| | E1 | E2 | E3 | E4 |
|---|---|---|---|---|
| Average neighbor | 3.9 | 3.4 | 2.6 | 2.1 |
| coordination | | | | |
| Porosity | 75% | 60% | 46% | 27% |
| Specific gravity | 416 | 656 | 528 | 712 |
| (kg/m³) | | | | |
| Air permeability, | 3.8*/10/11 | 1.13*/10/11 | 6.04*/10/12 | 9.0*/10/14 |
| Dracy's K (m²) | | | | |
| Average wall | 12.0 | 6.7 | 7.5 | 2.7 |
| thickness of | | | | |
| connected air | | | | |
| pores (μm) | | | | |
| Average wall | 62.9 | 43.0 | 41.8 | 32.8 |
| thickness of | | | | |
| unconnected air | | | | |
| pores (μm) | | | | |
| Average | 90.8 | 57.8 | 49.2 | 28.6 |
| equivalent | | | | |
| constriction | | | | |
| diameter (μm) | | | | |
| Average diameter | 258.8 | 136.9 | 114.4 | 68.6 |
| of connected air | | | | |
| pores (μm) | | | | |
| Mechanical | 28.6 | 94.4 | 62.4 | 148.4 |
| strength (N/mm) | | | | |

The average neighbor coordination, N (avg), of the air pores depending on the average diameter of the connected air pores for examples E1-E4 (solid circles).

The average neighbor coordination, N (avg), of air pores depending on the porosity, p, for examples E1-E4 (solid circles).

The average neighbor coordination, N (avg), of air pores depending on the density, d, for examples E1-E4 (solid circles).

FIG. 4 shows that at least 90% of the air pores in the examples according to the invention have a neighbor coordination of between 0 and 8, with a maximum occurrence of between 1 and 2. The average neighbor coordination, as reported in Table 2, is between 2 and 6. It is higher for E1 and E2, which are made from alpha hemihydrates, than for E3 and E4, which are made from beta hemihydrates.

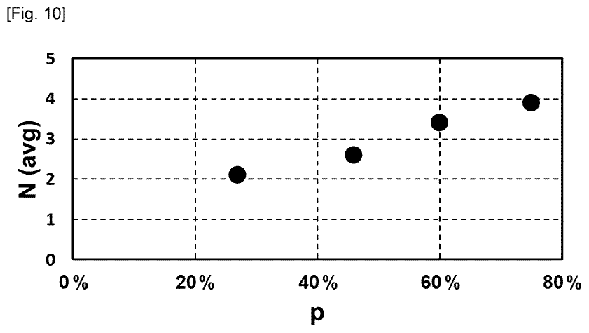

As shown in FIG. 10 and FIG. 11, for the same level of porosity or specific mass, the average neighbor coordination of connected air pores is higher for the examples than for the non-examples.

As shown in FIG. 5, the maximum occurrence of connected air pore wall thickness for examples E1-E4 is around 5 μm.

Examples of unconnected walls are shown in FIG. 6. The distribution is narrower for examples up to 150 μm, with maximum occurrence centered around 25 μm.

The cumulative volume distribution of connected and unconnected air pore diameters is shown in FIG. 7 and FIG. 8, respectively. At least 75% of the connected air pores in the examples have a diameter of less than 300 μm.

Around 90% of the unconnected air pores in the examples have a diameter of less than 100 μm.

All the embodiments and examples, including drawings, described herein, whether relating to the first or second aspect of the invention, may be combined by a person skilled in the art, unless they appear technically incompatible.

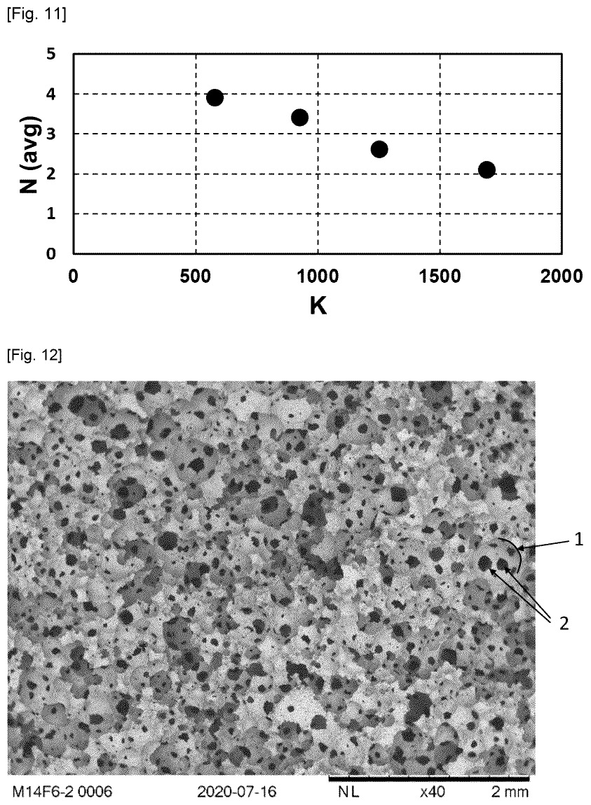

Referring now to FIG. 12, this is a scanning electron microscopy SEM photograph of the porous structure obtained according to Example 1 according to the invention. The connections (constrictions) 2 between the air pores 1 of said structure are shown in black. Assuming logically that the SEM image shows half of the substantially spherical outer volume of an air pore, it is possible to count the average neighbor coordination ratio of said air pores. The results are reported in Table 3 below. The average neighbor coordination for a half-sphere is 1.87, giving an overall coordination of 3.74, very close to the value of 3.9 obtained by X-ray tomography (see Table 2 above). The same analysis carried out on the SEM image of FIG. 1 of publication WO2022/153181 shows that the average neighbor coordination of the air pores in the structure obtained according to this prior art is of the order of 0.99.

TABLE 3

| | | | Average | Total |
|---|---|---|---|---|
| | | Number | coordination | average |
| | Number of | of air | on SEM | coordination |
| | constrictions | pores | image | (×2) |
| Example 1 | 288 | 154 | 1.870 | 3.74 |
| WO2022/153181 | 86 | 173 | 0.497 | 0.99 |

The results reported in Table 3 show that the teachings of WO2022/153181 lead to obtaining a porous structure of which the average coordination number of air pores is of the order of 1, contrary to the object of the present invention.

Furthermore, although the invention has been described in connection with preferred embodiments, it is to be understood that various modifications, additions and alterations may be made to the invention by a person skilled in the art without departing from the spirit and scope of the invention as defined in the claims.

1. A plasterboard comprising a plaster core arranged between two cover sheets;
wherein said plaster core comprises a matrix of gypsum crystals and air pores;
wherein at least 90% of the air pores are connected by a constriction; and
wherein an average neighbor coordination of the connected air pores is between 2 and 6.

2. The plasterboard according to claim 1, wherein a maximum volume of connected pores is at least 60%.

3. The plasterboard according to claim 1, wherein a specific mass of the matrix of gypsum crystals is at least 55% of a nominal specific mass of the plaster.

4. The plasterboard according to claim 1, wherein an average equivalent diameter of the air pore constrictions is less than 100 μm.

5. The plasterboard according to claim 1, wherein wall thicknesses of the connected air pores are between 2 μm and 20 μm, and wherein an average wall thickness of the connected pores is between 2 μm and 15 μm.

6. The plasterboard according to claim 1, wherein unconnected air pores are present in said plaster core and wall thicknesses of unconnected air pores are between 5 μm and 150 μm, and wherein the average wall thickness of the unconnected pores is between 25 μm and 75 μm.

7. The plasterboard according to claim 1, wherein an average diameter of air pores connected by a neighbor connectivity of between 2 and 6 is less than 300 μm.

8. The plasterboard according to claim 1, wherein a specific mass of the plasterboard is between 5 kg/m² and 15 kg/m².

9. The plasterboard according to claim 1, further comprising unconnected air pores, wherein an average diameter of the connected and unconnected air pores is less than 300 μm for an overall porosity of between 45% and 85%.

10. The plasterboard according to claim 1, wherein 85% of a porosity volume consists of air pores having a diameter which is greater than 100 μm.

11. The plasterboard according to claim 1, wherein at least 50% by volume of the air pores have a diameter of less than 150 μm, and wherein at least 25% by volume of the air pores have a diameter of greater than 100 μm.

12. The plasterboard according to claim 1, further comprising water pores, wherein 50% to 90% of the water pores have a diameter of less than 3 μm and wherein 5% to 30% of the water pores have a diameter of greater than 3 μm.

13. The plasterboard according to claim 1, wherein the plasterboard has an air permeability according to Darcy's law of between 10⁻¹⁰ and 10⁻¹³ m².

14. The plasterboard according to claim 1 wherein the average neighbor coordination of the connected air pores is between 3 and 6.

15. A method for producing the plasterboard according to claim 1, comprising, in the following order:
forming a plaster slurry comprising at least 90% alpha gypsum hemihydrate;
mixing the plaster slurry with a foaming agent in aqueous form;
foaming the mixture of the slurry with the foaming agent in aqueous form to form a foamed plaster slurry;
pouring the foamed plaster slurry onto a first cover sheet;
applying a second cover sheet to the foamed plaster slurry;
drying the foamed plaster slurry.

16. The method according to claim 15, wherein a water-to-stucco ratio of the plaster slurry is less than 0.5.
